(19) United States
(12) Patent Application Publication
(10) Pub. No.: US 2026/0128905 A1
(43) Pub. Date: May 7, 2026

(54) SYSTEMS AND METHODS FOR AN ENHANCED PASSKEY FOR USER ACCOUNT SECURITY

(71) Applicant: Wells Fargo Bank, N.A., San Francisco, CA (US)

(72) Inventors: Angela Sicord, San Francisco, CA (US); Matthew N. Wheeler, Charlotte, NC (US); John Andrew Chuprevich, Davidson, NC (US)

(21) Appl. No.: 18/936,654

(22) Filed: Nov. 4, 2024

(51) Int. Cl. H04L 9/32; H04L 9/08

(52) U.S. Cl. CPC H04L 9/3247; H04L 9/0825; H04L 9/3271

(57) ABSTRACT

Systems, apparatuses, methods, and computer program products are disclosed for an enhanced authentication using a super passkey. An example method includes receiving a user operation request from a user device and determining an authentication passkey requirement set comprising one or more authentication passkey requirements required for authentication of the user operation request. The example method further includes performing an authentication routine to determine whether to authenticate the user operation request. The authentication routine includes authenticating a digital signature provided by the user device using a public cryptographic key of a passkey for the user account and determining whether current user device data satisfies the one or more authentication passkey requirements. In an instance in which the user operation request is successfully authenticated, the example method further includes performing an operational routine associated with the operation request type for the user account.

### BACKGROUND

User account security is paramount for keeping sensitive user information safe and out of the hands of bad actors. Passkeys are designed to improve security and usability by providing passwordless authentication that leverages cryptographic keys to ensure only a legitimate user can access his/her user account.

### BRIEF SUMMARY

The use of passkeys for authentication is an improvement over the traditional password-based system. The traditional password method for user authentication typically relies on an alphanumeric string (e.g., a password) to grant access to a service and/or an account. The password used in this process may be stolen, guessed and/or cracked by cryptanalysis with relative ease. In contrast, the passkey system may leverage more secure cryptographic keys for user authentication. In particular, a user device locally stores a private cryptographic key and this key may be further secured through the various security systems on the user device (e.g., fingerprint recognition, face recognition, retinal scanning, and/or other biometric and security processes). A corresponding public cryptographic key is stored by the account service provider. The user may utilize the user device, registered to the passkey system, to request access to a service and/or an account. To allow access to a service and/or an account using a passkey, a digital challenge may be sent from the service provider to the user device. The private cryptographic key, accessed through the onboard security measures of the user device, may be used to sign the digital challenge, which is then sent back to the service provider for authentication. In an instance where the signature on the signed digital challenge corresponds to the stored public key, stored by the service provider, the user device is granted access to the desired service and/or account.

Traditionally, the user device only sends a signed response to the passkey system, and typically there has been no way to include additional user device data in the passkey authentication process. In addition, there is typically no way for the service provider to enact additional security requirements on the use of passkeys to access its service and/or account after the enrollment of the user device in the passkey authentication system. Additionally, the use of a passkey authentication only provides one type/level of authentication for all services that may be requested.

In contrast to these conventional techniques for passkey authentication, example embodiments herein describe a method for providing enhanced user account security by implementing an enhanced passkey authentication system that utilizes a “super passkey.” A super passkey may refer to a passkey for a user account and/or user device that is further associated with additional requirements defined in an authentication passkey requirement set. Thus, the passkey authentication system described herein may utilize traditional aspects of the passkey authentication process, including the use of both public and private cryptographic keys, stored by the service provider and the user device respectively, the signing of a challenge by the user device, and authentication of the signed challenge. However, the use of a super passkey may require the passkey authentication system to further evaluate user device data during the authentication process and determine an authentication result for a user operation request based on the user device data. More particularly, the user device data may be evaluated to determine whether one or more authentication passkey requirements of an authentication passkey requirement set are satisfied. A user operation request may be successfully authenticated in an instance a digital signature provided by the user device is successfully authenticated and each of the authentication passkey requirements are satisfied. Thus, use of a super passkey advantageously provides for improved security around the authentication process.

Prior to use of a super passkey for authentication, an authentication passkey requirement set must be generated for the user account. The authentication passkey requirement set may be generated based on received user configuration preferences received for a user account, as well as entity configuration security requirements. A user configuration preference may be a user-defined condition under which the passkey can be used for authentication, whereas an entity configuration security requirement may be entity-controlled and configured parameters that may place restrictions on the conditions under which a passkey can be used for authentication for individual users. Thus, both user-defined preferences and entity-defined protection measures and restrictions are considered when generating the authentication passkey requirement set for a user account of the user. In doing so, example embodiments described herein allow a user to customize his/her authentication preferences within the boundaries defined by the entity (e.g., the entity providing the user account) to ensure the security of the user account is maintained, thus providing a tailored, flexible, and secure authentication system for the user.

Upon receipt of a user operation request, an authentication routine may be performed to authenticate the user operation request. During the authentication routine, a challenge is provided to the user device and a digital signature provided by the user device may be evaluated with a public cryptographic key of the passkey to verify the digital signature. Additionally, during the authentication routine, the current user device data received from the user device is used to determine whether the authentication passkey requirement is satisfied. The enhanced security provided by the super passkey may be achieved through the analysis of current user device data provided to the passkey authentication system. The current user device data may be used to determine whether the one or more authentication passkey requirements are satisfied. In some embodiments, an authentication passkey requirement may define trusted locations, excluded locations, access windows or time frames, device identifiers, etc., within which a passkey can or cannot be used for authentication. The current user device data received from the user device may include location data, a time stamp, an indication of proximate user device identifiers, and/or the like.

Accordingly, the present disclosure sets forth systems, methods, and apparatuses that achieve an enhanced passkey for user account security. There are many advantages of these and other embodiments described herein. For instance, the additional security requirements for super passkey authentication may increase the trustworthiness or confidence in a user identity, user device identity, and/or in the legitimacy of a user operation request. Thus, authentication using a super passkey may enable the entity to authenticate user operation requests that would otherwise require additional authentication measures, such as multi-factor authentication. Additionally, authentication using a super passkey may further enable the entity to authenticate user operation requests that are traditionally not allowed to be authenticated digitally. For example, if the entity is a financial service provider and a super passkey is used, the entity may be able to authenticate user operation requests that are considered high risk or currently require an in-person visit to a financial institution branch. By way of particular example, a super passkey may enable authentication of user operation requests pertaining to transferring funds above a normal limit, linking the user account to external user accounts, applying for loans, opening a new account, changing user account information, resetting user account passwords, and/or the like.

The foregoing brief summary is provided merely for purposes of summarizing some example embodiments described herein. Because the above-described embodiments are merely examples, they should not be construed to narrow the scope of this disclosure in any way. It will be appreciated that the scope of the present disclosure encompasses many potential embodiments in addition to those summarized above, some of which will be described in further detail below.

### BRIEF DESCRIPTION OF THE FIGURES

Having described certain example embodiments in general terms above, reference will now be made to the accompanying drawings, which are not necessarily drawn to scale. Some embodiments may include fewer or more components than those shown in the figures.

FIG. 1 illustrates a system in which some example embodiments may be used.

FIG. 2 illustrates a schematic block diagram of example circuitry embodying a system device that may perform various operations in accordance with some example embodiments described herein.

FIG. 3 illustrates a schematic block diagram of example circuitry embodying a user device that may perform various operations in accordance with some example embodiments described herein.

FIG. 4 illustrates an example flowchart for enabling use of a super passkey with a user account, in accordance with some example embodiments described herein.

FIG. 5 illustrates an example flowchart for authenticating a user operation request using a super passkey, in accordance with some example embodiments described herein.

FIG. 6 illustrates an example flowchart for performing an authentication routine, in accordance with some example embodiments described herein.

FIG. 7 illustrates an example flowchart for the authenticating a digital signature provided by the user device during the authentication routine, in accordance with some example embodiments described herein.

FIG. 8 illustrates an example flowchart for the determining whether authentication passkey requirements are satisfied during the authentication routine, in accordance with some example embodiments described herein.

FIG. 9 illustrates an example flowchart for storing a device configuration set locally on a user device, in accordance with some example embodiments described herein.

### DETAILED DESCRIPTION

Some example embodiments will now be described more fully hereinafter with reference to the accompanying figures, in which some, but not necessarily all, embodiments are shown. Because inventions described herein may be embodied in many different forms, the invention should not be limited solely to the embodiments set forth herein; rather, these embodiments are provided so that this disclosure will satisfy applicable legal requirements.

The term “computing device” refers to any one or all of programmable logic controllers, programmable automation controllers, industrial computers, desktop computers, personal data assistants, laptop computers, tablet computers, smartbooks, palm-top computers, personal computers, smartphones, wearable devices (such as headsets, smartwatches, or the like), and similar electronic devices equipped with at least a processor and any other physical components necessarily to perform the various operations described herein. Devices such as smartphones, laptop computers, tablet computers, and wearable devices are generally collectively referred to as mobile devices.

The term “server” or “server device” refers to any computing device capable of functioning as a server, such as a master exchange server, web server, mail server, document server, or any other type of server. A server may be a dedicated computing device or a server module (e.g., an application) hosted by a computing device that causes the computing device to operate as a server.

### System Architecture

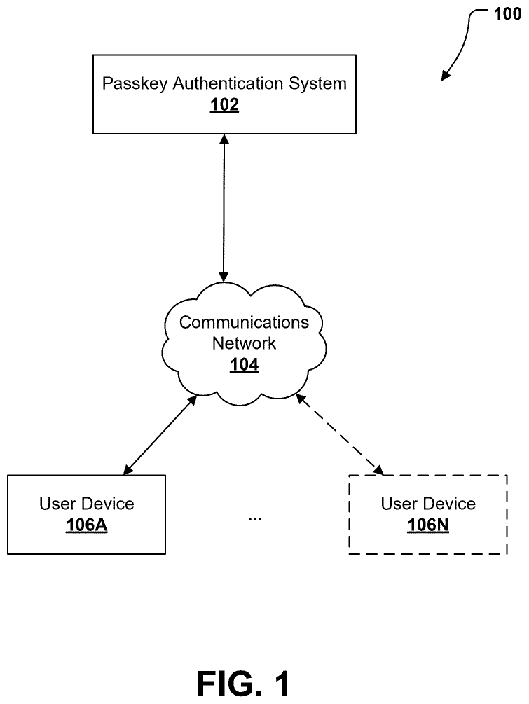

Example embodiments described herein may be implemented using any of a variety of computing devices or servers. To this end, FIG. 1 illustrates an example environment 100 within which various embodiments may operate. As illustrated, a passkey authentication system 102 may receive and/or transmit information via communications network 104 (e.g., the Internet) with any number of other computing devices, such as a user device (e.g., any one of the user devices 106A- 106N).

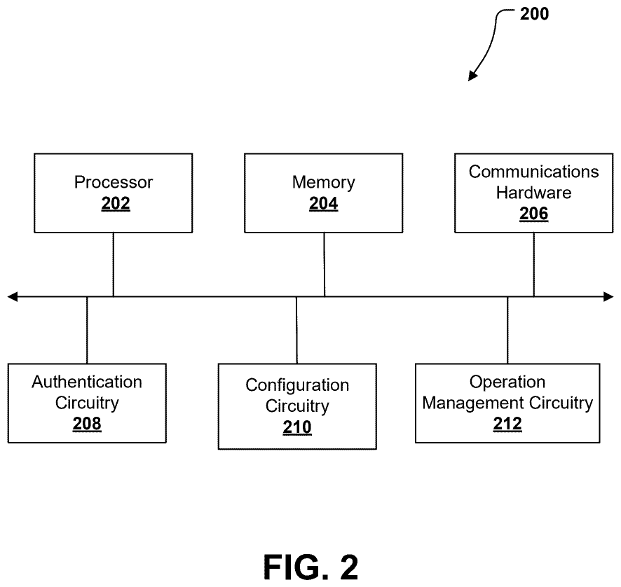

The passkey authentication system 102 may be implemented as one or more computing devices or servers, which may be composed of a series of components. Particular components of the passkey authentication system 102 are described in greater detail below with reference to the apparatus 200 in connection with FIG. 2.

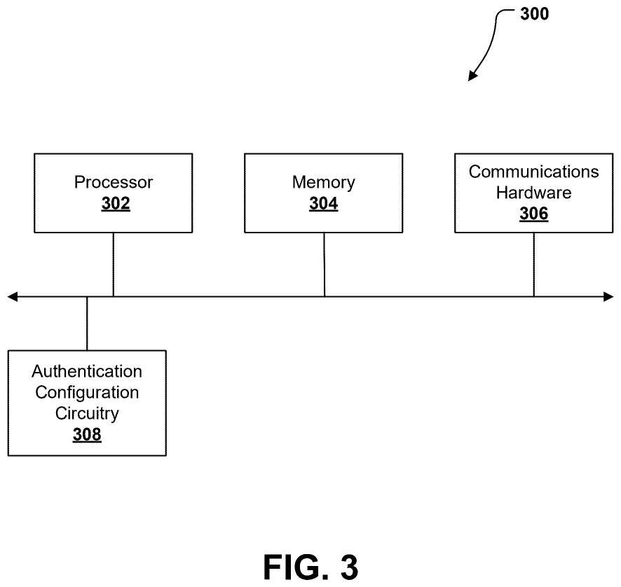

The one or more user devices (e.g., any one of the user devices 106A-106N) may be embodied by any computing devices known in the art (e.g., mobile phone, personal computer). The one or more user devices (e.g., any one of the user devices 106A-106N) may not be an independent device but may be a peripheral device communicatively coupled to other computing devices. In some embodiments, a user device (e.g., any one of the user devices 106A-106N) may be associated with a user who is associated with a user account maintained by the passkey authentication system 102 (e.g., a customer). Particular components of the user device (e.g., any one of the user devices 106A-106N) are described in greater detail below with reference to apparatus 300 in connection with FIG. 3.

### Example Implementing Apparatuses

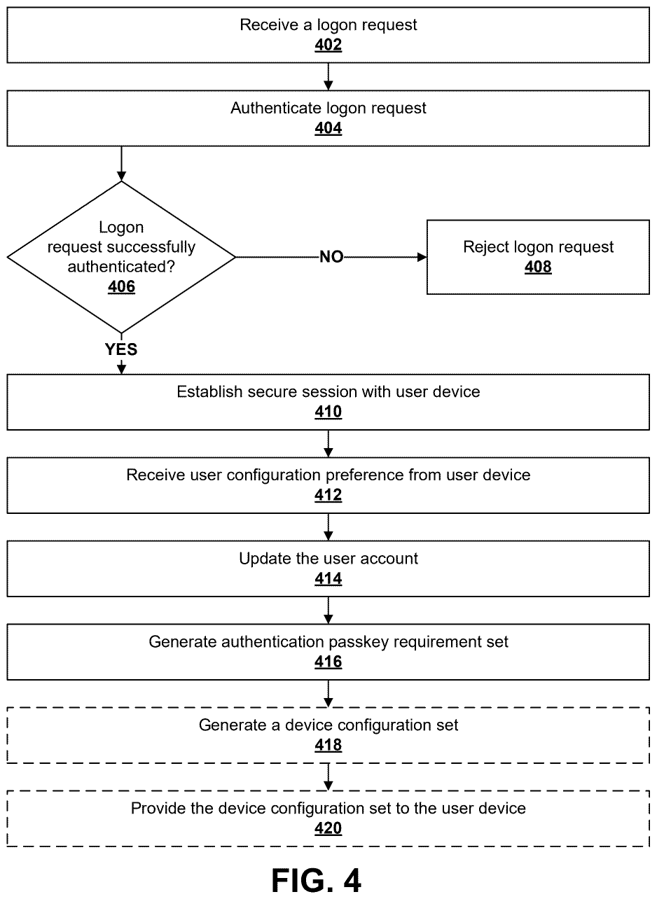

The passkey authentication system 102 (described previously with reference to FIG. 1) may be embodied by one or more computing devices or servers, shown as the apparatus 200 in FIG. 2. The apparatus 200 may be configured to execute various operations described above in connection with FIG. 1 and below in connection with FIG. 4-8. As illustrated in FIG. 2, the apparatus 200 may include the processor 202, the memory 204, the communications hardware 206, the authentication circuitry 208, the configuration circuitry 210, and the operation management circuitry 212, each of which will be described in greater detail below.

The processor 202 (and/or co-processor or any other processor assisting or otherwise associated with the processor) may be in communication with the memory 204 via a bus for passing information among components of the apparatus. The processor 202 may be embodied in a number of different ways and may, for example, include one or more processing devices configured to perform independently. Furthermore, the processor 202 may include one or more processors configured in tandem via a bus to enable independent execution of software instructions, pipelining, and/or multithreading. The use of the term “processor” may be understood to include a single core processor, a multi-core processor, multiple processors of the apparatus 200, remote or “cloud”processors, or any combination thereof.

The processor 202 may be configured to execute software instructions stored in the memory 204 or otherwise accessible to the processor. In some cases, the processor may be configured to execute hard-coded functionality. As such, whether configured by hardware or software methods, or by a combination of hardware with software, the processor 202 represents an entity (e.g., physically embodied in circuitry) capable of performing operations according to various embodiments of the present invention while configured accordingly. Alternatively, as another example, when the processor 202 is embodied as an executor of software instructions, the software instructions may specifically configure the processor 202 to perform the algorithms and/or operations described herein when the software instructions are executed.

The memory 204 is non-transitory and may include, for example, one or more volatile and/or non-volatile memories. In other words, for example, the memory 204 may be an electronic storage device (e.g., a computer-readable storage medium). The memory 204 may be configured to store information, data, content, applications, software instructions, or the like, for enabling the apparatus to carry out various functions in accordance with example embodiments contemplated herein.

The communications hardware 206 may be any means, such as a device or circuitry embodied in either hardware or a combination of hardware and software, that is configured to receive and/or transmit data from/to a network and/or any other device, circuitry, or module in communication with the apparatus 200. In this regard, the communications hardware 206 may include, for example, a network interface for enabling communications with a wired or wireless communication network. For example, the communications hardware 206 may include one or more network interface cards, antennas, buses, switches, routers, modems, and supporting hardware and/or software, or any other device suitable for enabling communications via a network. Furthermore, the communications hardware 206 may include the processing circuitry for causing transmission of such signals to a network or for handling receipt of signals received from a network.

The communications hardware 206 may further be configured to provide output to a user and, in some embodiments, to receive an indication of user input. In this regard, the communications hardware 206 may comprise a user interface, such as a display, and may further comprise the components that govern use of the user interface, such as a web browser, mobile application, dedicated client device, or the like. In some embodiments, the communications hardware 206 may include a keyboard, a mouse, a touch screen, touch areas, soft keys, a microphone, a speaker, and/or other input/output mechanisms. The communications hardware 206 may utilize the processor 202 to control one or more functions of one or more of these user interface elements through software instructions (e.g., application software and/or system software, such as firmware) stored on a memory (e.g., the memory 204) accessible to the processor 202.

In addition, the apparatus 200 further comprises the authentication circuitry 208, which may configured to determine an authentication passkey requirement set, perform an authentication routine, authenticate a digital signature, determine whether current user device data satisfies one or more authentication passkey requirements, and/or the like. In some embodiments, the authentication circuitry 208 may further be configured to determine a location of the user device from the current user device data and determine whether the location corresponds to a trusted location for the operation request type as defined by an authentication passkey requirement of the one or more authentication passkey requirements. In some embodiments, the authentication circuitry 208 may further be configured to determine a location of the user device from the current user device data and determine whether the location corresponds to an excluded location for the operation request type as defined by an authentication passkey requirement of the one or more authentication passkey requirements. In some embodiments, the authentication circuitry 208 may further determine a current time pertaining to the user device and determine whether the current time is within a trusted time frame for the operation request type as defined by an authentication passkey requirement of the one or more authentication passkey requirements. In some embodiments, the authentication circuitry 208 may determine a user device identifier corresponding to a second user device from the current user device data and determine whether the user device identifier corresponds to a trusted user device identifier defined by an authentication passkey requirement of the one or more authentication passkey requirements. In some embodiments, the authentication circuitry 208 may determine a current software application version for an associated software application installed on the user device from the current user device data and determine whether the current software application version satisfies a software application version threshold for the operation request type as defined by an authentication passkey requirement of the one or more authentication passkey requirements. The authentication circuitry 208 may utilize the processor 202, the memory 204, or any other hardware component included in the apparatus 200 to perform these operations, as described in connection with FIG. 4-8 below. The authentication circuitry 208 may further utilize the communications hardware 206 to gather data from a variety of sources (e.g., any one of the user devices 106A- 106N, as shown in FIG. 1) and/or exchange data with a user.

In addition, the apparatus 200 may further comprise the configuration circuitry 210, which may be configured to identify a user configuration preference set from the user account, identify an entity configuration security requirement set, and generate the authentication passkey requirement set. In some embodiments, the configuration circuitry 210 may update a user account to include a user configuration preference, generate a device configuration set, and/or the like. The configuration circuitry 210 may utilize the processor 202, the memory 204, or any other hardware component included in the apparatus 200 to perform these operations, as described in connection with FIG. 4-8 below. The configuration circuitry 210 may further utilize the communications hardware 206 to gather data from a variety of sources (e.g., any one of the user devices 106A- 106N, as shown in FIG. 1) and/or exchange data with a user.

Further, the apparatus 200 may further comprise the operation management circuitry 212, which may be configured to perform an operational routine. The operation management circuitry 212 may utilize the processor 202, the memory 204, or any other hardware component included in the apparatus 200 to perform these operations, as described in connection with FIG. 4-8 below. In various embodiments, the operation management circuitry 212 may utilize the communications hardware 206 to receive the user operation request from the user device (e.g., any one of the user devices 106A-106N). The operation management circuitry 212 may further utilize the communications hardware 206 to gather data from a variety of sources.

Although components 202-212 are described in part using functional language, it will be understood that the particular implementations necessarily include the use of particular hardware. It should also be understood that certain of these components 202-212 may include similar or common hardware. For example, the authentication circuitry 208, the configuration circuitry 210, and the operation management circuitry 212 may each, at times, leverage use of the processor 202, the memory 204, or the communications hardware 206, such that duplicate hardware is not required to facilitate operation of these physical elements of the apparatus 200 (although dedicated hardware elements may be used for any of these components in some embodiments, such as those in which enhanced parallelism may be desired). Use of the term “circuitry” with respect to elements of the apparatus 200 therefore shall be interpreted as necessarily including the particular hardware configured to perform the functions associated with the particular element being described. Of course, while the term “circuitry” should be understood broadly to include hardware, in some embodiments, the term “circuitry” may in addition refer to software instructions that configure the hardware components of the apparatus 200 to perform the various functions described herein.

Although the authentication circuitry 208, the configuration circuitry 210, and the operation management circuitry 212 may leverage the processor 202, the memory 204, or the communications hardware 206 as described above, it will be understood that any of the authentication circuitry 208, the configuration circuitry 210, and the operation management circuitry 212 may include one or more dedicated processors, specially configured field programmable gate arrays, or application-specific interface circuits to perform its corresponding functions and may accordingly leverage the processor 202 executing software stored in a memory (e.g., the memory 204) or the communications hardware 206 for enabling any functions not performed by special-purpose hardware. In all embodiments, however, it will be understood that the authentication circuitry 208, the configuration circuitry 210, and the operation management circuitry 212 comprise particular machinery designed for performing the functions described herein in connection with such elements of the apparatus 200.

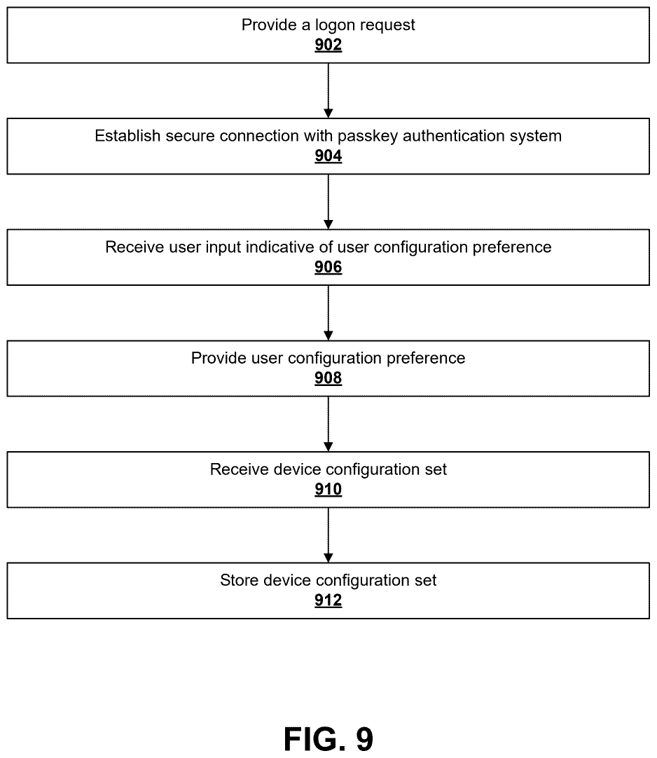

As illustrated in FIG. 3, the apparatus 300 is shown, which represents an example user device (e.g., any one of the user devices 106A-106N). The apparatus 300 includes the processor 302, the memory 304, and the communications hardware 306, and it may include the authentication configuration circuitry 308, which includes hardware components configured to access device configurations set and provide current user device data in conjunction with a user operation request. The authentication configuration circuitry 308 may utilize the processor 302, the memory 304, or any other hardware component included in the apparatus 300 to perform these operations, as described in connection with FIG. 9 below. The authentication configuration circuitry 308 may utilize the communications hardware 306 to locally store a device configuration set. In some embodiments, the user device (e.g., any one of the user devices 106A-106N represented by the apparatus 300) may further utilize the communications hardware 306 to communicate user operation requests to the passkey authentication system 102.

In some embodiments, various components of the apparatuses 200 and 300 may be hosted remotely (e.g., by one or more cloud servers) and thus need not physically reside on the corresponding apparatus 200 or 300. For instance, some components of the apparatus 200 may not be physically proximate to the other components of the apparatus 200. Similarly, some or all of the functionality described herein may be provided by third-party circuitry. For example, a given apparatus 200 may access one or more third-party circuitries in place of local circuitries for performing certain functions.

As will be appreciated based on this disclosure, example embodiments contemplated herein may be implemented by the apparatus 200 or 300. Furthermore, some example embodiments may take the form of a computer program product comprising software instructions stored on at least one non-transitory computer-readable storage medium (e.g., the memory 204). Any suitable non-transitory computer-readable storage medium may be utilized in such embodiments, some examples of which are non-transitory hard disks, CD-ROMs, DVDs, flash memory, optical storage devices, and magnetic storage devices. It should be appreciated, with respect to certain devices embodied by the apparatus 200 as described in FIG. 2 or the apparatus 300 as described in FIG. 3, that loading the software instructions onto a computing device or apparatus produces a special-purpose machine comprising the means for implementing various functions described herein.

Having described specific components of example apparatuses 200 and 300, example embodiments are described below in connection with a series of flowcharts.

### Example Passkey Authentication System Operations

Turning to FIG. 4-8, example flowcharts are illustrated that contain example operations implemented by example embodiments described herein. The operations illustrated in FIG. 4-8 may, for example, be performed by the passkey authentication system 102 shown in FIG. 1, which may in turn be embodied by the apparatus 200, which is shown and described in connection with FIG. 2. To perform the operations described below, the apparatus 200 may utilize one or more of the processor 202, the memory 204, the communications hardware 206, the authentication circuitry 208, the configuration circuitry 210, the operation management circuitry 212, and/or any combination thereof. It will be understood that user interaction with the passkey authentication system 102 may occur directly via the communications hardware 206 or may instead be facilitated by a separate user device (e.g., any one of the user devices 106A-106N), as shown in FIG. 1, and example apparatus, as shown in FIG. 3, and that may have similar or equivalent physical componentry facilitating such user interaction.

### Example Operations for Enabling Use of a Super Passkey

Turning first to FIG. 4, example operations are shown for enabling use of a super passkey with a user account. A super passkey may refer to a passkey for a user account and/or user device that is further associated with additional requirements defined in an authentication passkey requirement set. Thus, a user device may be required to provide additional user device data in addition to a signed challenge in order for an operation request to be authenticated. Prior to use of a super passkey for authentication, an authentication passkey requirement set must be generated for the user account. The authentication passkey requirement set may be used in conjunction with the signed challenge provided by the user device when authenticating a particular user operation request.

As shown by operation 402, the apparatus 200 includes means, such as the communications hardware 206 or the like, for receiving a logon request for the user account. The communications hardware 206 may receive a logon request from a user device, such as the user device 106A, when a user attempts to log into a user account using an associated software application. In some embodiments, the logon request may be a request to access the user account within the software application. In some embodiments, the software application is a mobile application or a native application that is configured to execute on the user device 106A.

The logon request described in operation 402 may be received prior to the user configuring his/her user account with an authentication passkey requirement set. The logon request may include a candidate user identifier (e.g., a username, email, customer number, and/or the like) and candidate user credentials (e.g., a password, biometric data, personal identification number (PIN), and/or the like). Additionally, or alternatively, the logon request may include an indication of the user device 106A. For example, the logon request may include a device identifier, such as a media access control (MAC) address, an Internet Protocol (IP) address, international mobile equipment identifier (IMEI) number, phone number, a mobile equipment identifier (MEID), a unique device identifier (UDID), a hardware identifier, an electronic serial number, or any other identifier that uniquely identifies the particular user device. In some embodiments, the logon request may be received using a hypertext transfer protocol (HTTP) or HTTP secure (HTTPS) protocol (e.g., an HTTP/HTTPS request). In some embodiments, the communications hardware 206 may receive the logon request using specific application program interfaces (APIs), such as representational state transfer APIs (RESTful APIs) or WebSocket APIs.

As shown by operation 404, the apparatus 200 includes means, such as the memory 204, the communications hardware 206, the authentication circuitry 208, or the like, for authenticating the logon request based on user credentials provided in the logon request. The authentication circuitry 208 may authenticate the logon request for a user account as received from the user device 106A using the candidate user credentials provided in the logon request and stored user credentials associated with the user account. In particular, the authentication circuitry 208 may use the candidate user identifier to identify a corresponding user account and determine stored user credentials associated with the user account. In an instance in which the received candidate user credentials sufficiently correspond or match corresponding stored user credentials, the authentication circuitry 208 may successfully authenticate the user and the logon request. Alternatively, in an instance in which the received candidate user credentials fail to sufficiently correspond to or match the stored user credentials, the authentication circuitry 208 may fail to authenticate the user and the logon request.

The authentication circuitry 208 may authenticate the logon request based on the user credential type of the candidate user credential received in the logon request. For example, the candidate user credential may correspond to a user credential type, such as a passkey, password, biometric data, PIN, etc. The authentication circuitry 208 may be configured to identify the user credential type of the candidate user credential in the logon request and then perform an authentication protocol based on the user credential type. In some embodiments, the particular authentication protocol used to authenticate the logon request may be stored in an associated memory, such as the memory 204. The authentication protocol may describe operations the authentication circuitry 208 may perform to authenticate the logon request, including algorithms or models used in the authentication, various thresholds (e.g., a similarity score threshold), a number of logon request reattempts able to be received from the user device 106A, and/or the like.

For example, for a candidate user credential that is a password, the authentication circuitry 208 may use a hashing function to hash the characters of the candidate password and then compare the hashed candidate password to a hashed stored password. In an instance in which the corresponding characters of the hashed candidate password and hashed stored password exactly match, the authentication circuitry 208 may determine the candidate user credentials sufficiently match the stored user credentials.

In some embodiments, the authentication circuitry 208 may use one or more models to determine whether the candidate user credentials sufficiently match the stored user credentials. For example, in an instance in which a candidate user credential corresponds to biometric data (e.g., fingerprint data, facial image data, retina data, or the like), the authentication circuitry 208 may be configured to use one or more biometric matching machine-learning models to determine a similarity score between the biometric data of the candidate user credential and the corresponding biometric data of the stored user credential. In an instance in which the similarity score satisfies one or more similarity thresholds, the authentication circuitry 208 may determine that the candidate user credential sufficiently matches the stored user credential.

As shown by operation 406, the apparatus 200 includes means, such as the authentication circuitry 208 or the like, for determining whether the logon request was successfully authenticated. As described in operation 404, authentication circuitry 208 may authenticate the logon request based on the candidate user credential included in the logon request. If the authentication circuitry 208 fails to authenticate the logon request, the authentication circuitry 208 may reject the logon request, as described in operation 408. If the authentication circuitry 208 successfully authenticates the logon request, the communications hardware 206 may establish a secure session with the user device 106A, as described in operation 410.

If the logon request fails to be successfully authenticated, the process may proceed to operation 408. As shown by operation 408, the apparatus 200 includes means, such as the communications hardware 206, the authentication circuitry 208, or the like, for rejecting the logon request. If the logon request fails to be authenticated, the authentication circuitry 208 may be unable to verify the identity of the user and, thus, will not establish a secure session nor provide user account information to the user device 106A. Thus, the user will not be able to provide user configuration preferences and an authentication passkey requirement set will not be generated. In this way, the security of the user account is maintained by prohibiting the user account from being configured with an authentication passkey requirement set unless the logon request is successfully authenticated, thereby indicating confirmation of the requesting user identity.

In some embodiments, the authentication circuitry 208 may generate a denial message and use the communications hardware 206 to provide the denial message to the user device 106A. The denial message may include feedback on why the logon request has been denied. For example, the denial message may indicate that the provided password does not match a stored password or a user account associated with the user credential cannot be found. In some embodiments, the denial message may prompt the user to retry the logon process. The user may reattempt a logon request a threshold number of times (e.g., as defined by the authentication protocol) before the user account is locked.

If the logon request was successfully authenticated, the process may proceed to operation 410. As shown by operation 410, the apparatus 200 includes means, such as the memory 204, the communications hardware 206, the authentication circuitry 208, or the like, for establishing a secure session with the user device. Once the logon request has been successfully authenticated, the authentication circuitry 208 may generate a session token that can be used to track a user's session until the session expires or the user logs out of the software application. The authentication circuitry 208 may store this session token in a memory, such as the memory 204, and may provide the session token to the user device 106A using the communications hardware 206. The communications hardware 206 may provide the session token in a response (e.g., an HTTP/HTTPS response), which may also include user account data for the user account, to the software application running on the user device 106A. In some embodiments, the communications hardware 206 may use specific APIs, such as RESTful APIs or WebSocket APIs, to provide user account data to the software application.

Once the session token and user account data are provided to the software application running on the user device 106A, an authenticated session may be successfully established. The authenticated session may continue until a termination event occurs. A termination event may be the user logging out of the session. Alternatively, the termination event may be a timeout event, where the software application running on the user device 106A experiences a period of inactivity for a length of time that exceeds an inactivity time threshold (e.g., 10 minutes). Alternatively, a termination event may be the expiration of the session token. In an instance a termination event occurs, the user may be required to provide another logon request to establish a new authenticated session or reestablish the authenticated session.

As shown by operation 412, the apparatus 200 includes means, such as the communications hardware 206, the configuration circuitry 210, or the like, for receiving a user configuration preference from a user device. In various embodiments, during the secure session, the user may input his/her preferences for use of a passkey with his/her user account. A user-submitted preference may be a user configuration preference. A user configuration preference may define a user-defined condition under which the passkey can be used for authentication. In some embodiments, the communications hardware 206 may receive one or more user configuration preferences from the user device 106A. The communications hardware 206 may provide the received user configuration preferences to the configuration circuitry 210 if the session with the user device 106A is still active or live (e.g., not timed out or terminated).

As described above, a user configuration preference may define a user-defined condition under which the passkey can be used for authentication. For example, a user configuration preference may define that a passkey associated with a user device and/or user account may only be used when the user is at a particular geographic location. By way of particular example, a user configuration preference may define geographic locations within which a passkey may be used for authentication. That is, a passkey may be used when a user device location corresponds to a particular address, such as a user's residential address or work address. In some embodiments, a user may define trusted locations within his/her user account. The user configuration preference may then define that a passkey may only be used when the user device is within a trusted location.

As another example, a user configuration preference may define geographic locations within which a passkey cannot be used for authentication. That is, a passkey cannot be used when a user device location corresponds at a particular address. In some embodiments, a user may define excluded locations within his/her user account. The user configuration preference may then define that a passkey cannot be used when the user device is within an excluded location.

As another example, a user configuration preference may define a time frame within which a passkey can or cannot be used for authentication. That is, a user configuration preference may define a time frame during which a passkey can be used for authentication. Alternatively, a user configuration preference may define a time frame during which a passkey cannot be used for authentication. By way of particular example, a user configuration preference may define that a passkey may be used for authentication between the hours of 8:00 a.m. and 10:00 p.m. Additionally, or alternatively, a user configuration preference may define that a passkey cannot be used for authentication between the hours of 10:00 p.m. and 8:00 a.m.

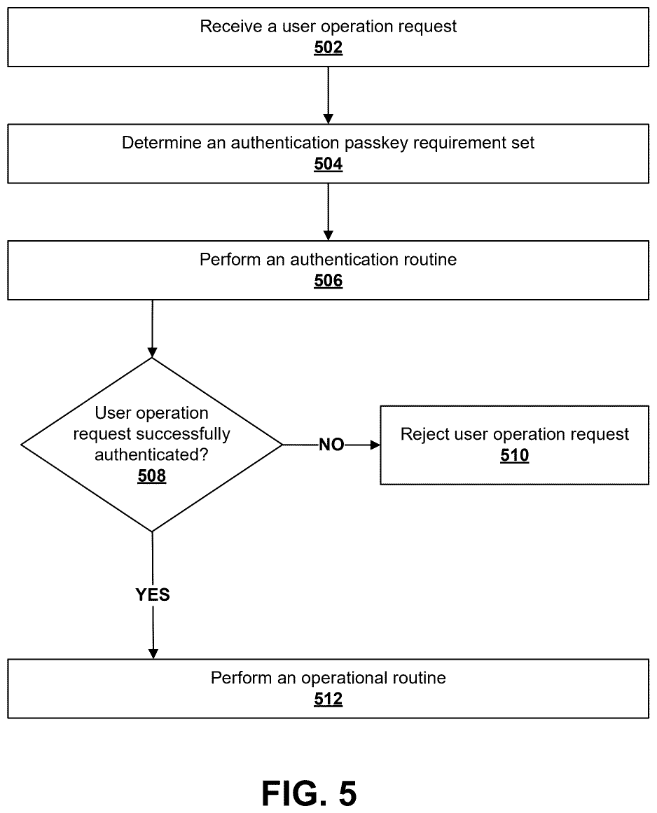

As another example, a user configuration preference may define the presence of a device identifier of another user device (e.g., a user device other than the user device performing the authentication) is required in order for the passkey to be used for authentication. By way of particular example, the presence of nearby, trusted user devices belonging to the user or another trusted user (e.g., a spouse, friend, colleague, or the like) may be required for a passkey to be used for authentication. A device identifier may uniquely identify the proximate user device. For example, the device identifier may be a MAC address, an IMEI number, an MEID, a UDID, a hardware identifier, an electronic serial number, or any other identifier that uniquely identifies the particular user device. As described in further detail in FIG. 5, the user device performing the authentication, such as the user device 106A, may request the required device, such as the user device 106N, to provide a user identifier. Prior to the provision of the user configuration preference, the user device 106A may request the desired other user device, such as the user device 106N, to provide its device identifier. In this way, the user configuration preference provided by the user device 106A may include the device identifier data for the desired user device.

In some embodiments, a user configuration preference may further define particular user operations to which other user configuration preferences should be applied. For example, a user configuration preference may define that when a user is attempting to perform a transfer (e.g., a user operation) from a payment account associated with the user account, a passkey may be required. Further, the location of the user device attempting the transfer may be required to provide its location and a time for authentication. In this way, conditions for specific user operations may be defined. This provides for robust and flexible authentication that may be tailored for specific user operations.

As shown by operation 414, the apparatus 200 includes means, such as the configuration circuitry 210 or the like, for updating the user account. The configuration circuitry 210 may receive the user configuration preferences from the communications hardware 206. The configuration circuitry 210 may then update the user account to reflect the user configuration preferences received from the user device. In particular, the configuration circuitry 210 may generate a new user configuration preference for a user configuration preference set included in the user account if the user configuration preference set does not include a corresponding user configuration preference. Alternatively, the configuration circuitry 210 may update or replace a current user configuration preference in the user configuration preference set with the received user configuration preference. The configuration circuitry 210 may therefore update the user configuration preference set within the user account to reflect accurate and responsive user preferences as received by the user.

As shown by operation 416, the apparatus 200 includes means, such as the memory 204, the configuration circuitry 210, or the like, for generating an authentication passkey requirement set. An authentication passkey requirement set may include one or more authentication passkey requirements that each define requirements for authentication of the user operation request. The configuration circuitry 210 may generate the authentication passkey requirement set based on the user configuration preference set. Additionally, the configuration circuitry 210 may generate the authentication passkey requirement set based on an entity configuration security requirement set.

The configuration circuitry 210 may identify the user configuration preference set from the user account. As described above, a user configuration preference may define a user-defined condition under which the passkey can be used for authentication. In some embodiments, in addition to the user preference set, the configuration circuitry 210 may also use the entity configuration security requirement set to generate an authentication passkey requirement set. The entity configuration security requirement set may be stored in a memory, such as the memory 204, and the configuration circuitry 210 may be configured to access the entity configuration security requirement set from the memory 204 when generating the authentication passkey requirement set.

The entity configuration security requirement set may include one or more entity configuration security requirements. Each entity configuration security requirement may define an entity-defined condition under which a passkey can be used for authentication. The entity configuration security requirement set may be set by a privileged user associated with the apparatus 200 (e.g., an administrator employed by an entity associated with the apparatus 200). An entity configuration security requirement may not be set by individual users (e.g., users associated with the user devices 106A-106N). Thus, entity configuration security requirements may be entity-controlled and configured parameters that may place restrictions on the conditions under which a passkey can be used for authentication for individual users.

In some embodiments, the entity configuration security requirement may define a required software application version for an associated software application installed on a requesting user device. For example, an entity configuration security requirement may require that a requesting user device have at least a current software application version equivalent or more recent than the required software application version. This mechanism ensures the user is using an updated application that may have improved security features and, as such, may improve security for the user.

The entity configuration security requirements may supersede or override user configuration preferences. If an entity configuration security requirement and user configuration preference conflict, the configuration circuitry 210 may select the entity configuration security requirement and ignore the user configuration requirement. This allows for responsive and robust security metrics to be instilled within the authentication passkey requirement set.

In some embodiments, the entity configuration security requirement may define geographic locations within which a passkey cannot be used for authentication. In some embodiments, an entity configuration security requirement may define excluded locations that cannot be used for authentication by a user. In some embodiments, an entity configuration security requirement may define excluded or prohibited device identifiers. That is, if a prohibited device identifier is detected within proximity of a requesting user device, a passkey cannot be used for authentication. As described above, entity configuration security requirements may supersede or override user configuration preferences. For example, an entity configuration security requirement may define that geographic area A is an excluded geographic location. A user account may list that geographic area B, which is within geographic area A, and geographic area C are trusted locations. The user account may further include a user configuration preference that defines that passkey authentication should be enabled in all trusted locations. When generating the authentication passkey requirement set, the configuration circuitry 210 may identify that the entity configuration security requirement and user configuration preference conflict. To resolve the conflict, the configuration circuitry 210 may ignore or discard the conflicting portion of the user configuration preference (e.g., geographic area B). This may be done in numerous ways, such as generating an authentication passkey requirement that creates an exception to explicitly prohibit the use of geographic area B, generating an authentication passkey requirement that allows for use of a passkey in geographic area C, and/or the like.

In some embodiments, if the configuration circuitry 210 identifies a conflict, the configuration circuitry 210 may cause the communications hardware 206 to provide a conflict message to the user device 106A. This conflict message may be indicative of the identified conflict, thereby alerting the user that an input user configuration preference is not currently implemented. In some embodiments, this conflict message may be provided to the user directly after receipt of the conflicting user configuration preference and/or a user account change. By way of continuing example, if the user had submitted a user configuration preference to enable a passkey to be used for authentication in all trusted geographic locations, the communications hardware 206 may provide the conflict message to the user device 106A. The conflict message may indicate that a passkey cannot be used for authentication within geographic area B for security reasons.

As described above, the configuration circuitry 210 may generate authentication passkey requirements based on the user configuration preference set and the entity configuration security requirement set. Each authentication passkey requirement may define a rule, requirement, or condition for when a passkey may be used for a user and/or the user device 106A for authentication. As described in more detail in FIG. 5, if each authentication passkey requirement in the authentication passkey requirement set is satisfied, a user or the user device 106A may be enabled to use a passkey for authentication. Once the configuration circuitry 210 has generated the authentication passkey requirement set, the configuration circuitry 210 may store the authentication passkey requirement set in an associated memory, such as the memory 204.

In some embodiments, a user account may already be configured with a passkey. However, the current passkey may only be associated with limited authentication privileges (e.g., enables a user device to login to the user account). The passkey may further be associated with the authentication passkey requirement set and, in doing so, becomes a super passkey that may have enhanced authentication privileges. In some embodiments, the user configuration preference may specify a particular passkey within the user account to associate with the authentication passkey requirement set. Thus, the authentication passkey requirement set may be stored in the memory 204 and only associated with the specified passkey. In some embodiments, if the user account has multiple associated passkeys (e.g., passkeys associated with different user devices), a different authentication passkey requirement set may be associated with each user device. Alternatively, two or more user devices may share an authentication passkey requirement set if specified by the user.

In some embodiments, an authentication passkey requirement may pertain to one or more operation request types. As described above, a user configuration preference may further define particular user operations to which other user configuration preferences should be applied. Thus, in some embodiments, the configuration circuitry 210 may configure and/or associate authentication passkey requirements with operation request types, such that one or more different authentication passkey requirements may be used to authenticate different operation request types. By way of particular example, an authentication passkey requirement for enabling a passkey for authentication only at a residential address may be associated only with an operation request type for transferring funds above a particular limit. Thus, this authentication passkey requirement may be ignored for other operation request types. As another example, an authentication passkey requirement for enabling a passkey for authentication only between the hours of 8:00 a.m. and 11:00 p.m. may be associated with every operation request type. Thus, this authentication passkey requirement may be required for each operation request type. As yet another example, enabling a passkey for authentication at a trusted location may be associated with every operation request type except an operation request type for a logon request. Thus, this authentication passkey requirement may be ignored only for a logon request type but required by the other operation request types.

Optionally, as shown by operation 418, the apparatus 200 includes means, such as the memory 204, the configuration circuitry 210, or the like, for generating a device configuration set. In various embodiments, the configuration circuitry 210 may generate a device configuration set for a user device of the user, such as the user device 106A. The device configuration set may include one or more configuration parameters that are intended to be stored locally on the user device 106A. A device configuration parameter may provide data and/or instructions for the user device when performing authentication for the user with the apparatus 200. In some embodiments, a device configuration parameter may instruct the user device 106A to provide certain user device data, such as a user device location, a current time, proximate device identifiers detected, and/or the like. Device configuration parameters may further instruct the user device 106A to provide certain user device data for a particular user operation request. Additionally, in some embodiments, device configuration parameters may instruct the user device 106A to provide user device data in a particular manner. For example, a device configuration parameter may instruct the user device 106A to provide a device configuration parameter over a particular communication channel, using a particular frequency, separately or with other user device data and/or a signed challenge, in a protected manner (e.g., a particular encryption technique), and/or the like.

The configuration circuitry 210 may generate the device configuration set based on the authentication passkey requirement set. In some embodiments, the configuration circuitry 210 may access the authentication passkey requirement set from its stored location, such as from the memory 204, and use the authentication passkey requirement set to generate device configuration parameters. The device configuration set may instruct the user device 106A to provide user device data to allow the apparatus 200 to proactively receive the required information from the user device 106A. In this way, the device configuration set may ensure efficient and streamlined communication between the apparatus 200 and the user device 106A by eliminating the need for the apparatus 200 to request data required for authentication with a passkey. Instead, the user device 106A may use the device configuration set to proactively provide the required data, thereby conserving network bandwidth usage. Furthermore, the user device 106A may use the device configuration set to identify the required user device data needed for a particular authentication and then provide only the required data. Effectively, this allows the user device 106A to reduce the communication payload to only the required user device data, thereby further reducing network bandwidth usage.

Optionally, as shown by operation 420, the apparatus 200 includes means, such as the communications hardware 206 or the like, for providing the device configuration set to the user device. In some embodiments, the configuration circuitry 210 may instruct the communications hardware 206 to provide the device configuration set to the user device 106A. In particular, the communications hardware 206 may provide the device configuration set to the user device 106A with which the apparatus 200 currently has a secure session. In some embodiments, the communications hardware 206 may be configured to provide the device configuration set to other trusted devices listed in the user account. In response to receipt of the device configuration set, a recipient user device 106A may be configured to locally store the device configuration set, such as in the memory 204.

In some embodiments, operations 412-420 may repeated in an instance in which a new user configuration parameter is received from a user device with an established secure session with the user account. Additionally, operations 416-420 may be repeated in response to a user account update. For example, a user account update that reflects a new trusted location; a new trusted user device; a new residential, work, or other address update; etc., may each cause the configuration circuitry 210 to perform operations 416-420. Thus, the authentication passkey requirement set and the device configuration set may be updated in real time or near real time and in response to user account changes. In doing so, the authentication passkey requirement set is updated to ensure and maintain user account security and/or the device configuration set is updated to ensure efficient communication between user devices and the apparatus 200.

### Example Operations for Authenticating Using a Super Passkey

Turning now to FIG. 5, example operations are shown for authenticating a user operation request using a super passkey. Once a user account is configured with a super passkey (e.g., a passkey that is associated with an authentication passkey requirement set), user operation requests may be handled using the super passkey. In particular, a user operation request may be authenticated using a digital signature and current user device data received from a requesting user device. If the digital signature is successfully authenticated and the authentication passkey requirements are satisfied, the user operation request may be successfully authenticated and an associated operational routine may be performed. Authentication through use of a super passkey may allow for enhanced, complex, or traditionally unavailable user operation requests to be authenticated due to the increased security requirements enforced by the authentication routine associated with the super passkey.

As shown by operation 502, the apparatus 200 includes means, such as the communications hardware 206, the authentication circuitry 208, or the like, for receiving a user operation request. In some embodiments, the communications hardware 206 may receive the user operation request from a user device, such as the user device 106A. In some embodiments, the communications hardware 206 may receive the user operation request from the user device 106A during a secure session. The secure session may be established as described in operations 402-410 of FIG. 4. Alternatively, the communications hardware 206 may receive the user operation request from the user device 106A without the user device having established a secure session. In some embodiments, the user operation request may be the logon request. In some embodiments, the user operation request may be received using a HTTP/HTTPS protocol (e.g., an HTTP/HTTPS request) or using an API.

A user operation request may describe a requested operation to be performed for a particular user account. In some embodiments, the user operation request may correspond to an operation request type. An operation request type may correspond to a particular category of predefined user request types. Each operation request type may be associated with an operational routine. Before an operational routine can be performed, the user operation request may first need to be authenticated using a super passkey. In some embodiments, the authentication circuitry 208 may identify the operation request type of the user operation request and determine whether the operation request type is associated with an authentication requirement. If the operation request type is associated with an authentication requirement, the authentication circuitry 208 may proceed to operation 504.

For example, an operation request type may be a user account logon request, a fund transfer request, a user account update request, an account opening request, and/or the like. A received user operation request may further include user-supplied data for the particular user operation request. The user-supplied data may be dependent upon the operation request type. By way of continuing example, user-supplied data for a logon request may include a candidate user identifier. As another example, user-supplied data for a fund transfer request may include a provisioning account, a recipient account, a fund amount, and a memo line. As another example, user-supplied data for a user account update request may include a user input value for a particular user account data field (e.g., legal name, residential address, work address, phone number, trusted user devices, trusted locations, or the like). As another example, user-supplied data for an account opening request may include various demographic information, a social security number, a phone number, an email address, etc. In some embodiments, the user may provide the user-supplied information to the user device 106A within the associated software application. In turn, the software application may provide the specific information from the user associated with the user operation request.

The user operation request may further pertain to a user account. In some embodiments, in an instance in which a secure session is currently established with the user device 106A, the session token may identify the corresponding user account. Additionally, or alternatively, the user operation request may include an account identifier, such as a candidate user identifier, which the authentication circuitry 208 (or another circuitry of the apparatus 200) may use to identify the user account.

Additionally, in some embodiments, the user operation request may identify the particular user device from which the user operation request is received from. For example, the user operation request may be a device identifier of the user device 106A, such as a MAC address, an IP address, IMEI number, phone number, an MEID, a UDID, a hardware identifier, an electronic serial number, etc.

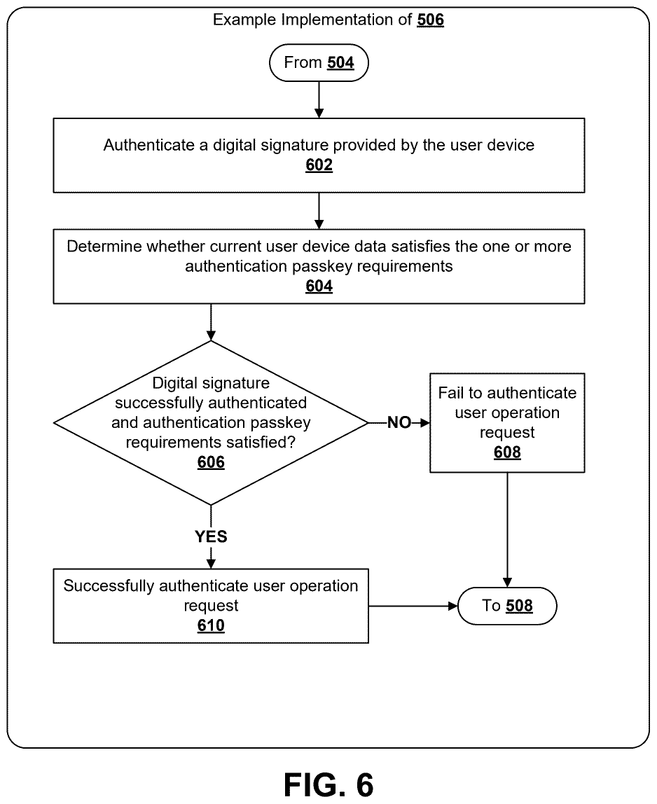

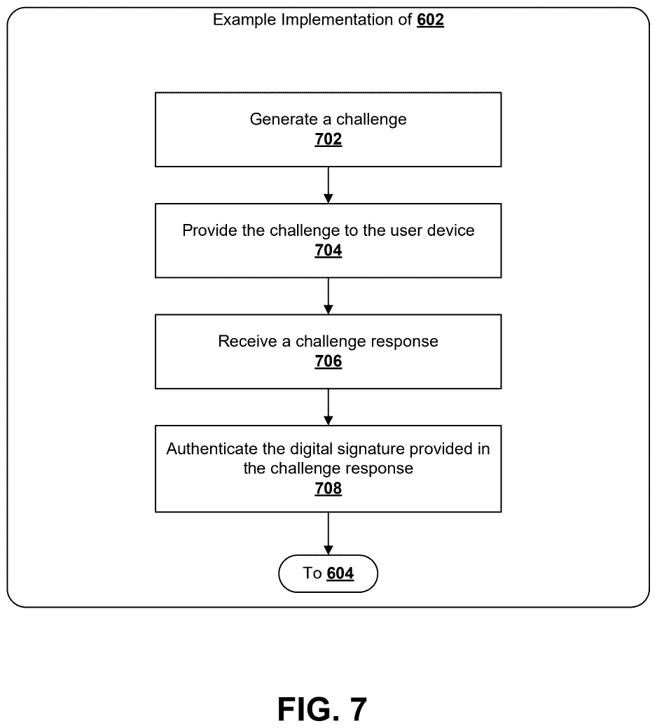

In some embodiments, the user operation request may further include user device data. If the user device 106A is configured with a locally stored device configuration set, the user device 106A may proactively provide user device data to be used by the authentication circuitry 208 during performance of the authentication routine. In some embodiments, the user device data may be received with the user operation request, during the authentication routine as described in FIGS. 6 and 7, or in one or more separate communications.

As shown by operation 504, the apparatus 200 includes means, such as the memory 204, the authentication circuitry 208, or the like, for determining an authentication passkey requirement set. Once the communications hardware 206 receives a user operation request from the user device, the authentication circuitry 208 may determine the authentication passkey requirement set to be used for authentication. As described in FIG. 4, the authentication passkey requirement set may be stored in an associated memory, such as the memory 204. The authentication circuitry 208 may be configured to identify and select the authentication passkey requirement set associated with the user account from the memory 204.

In some embodiments, the stored authentication passkey requirement set may be associated with a particular passkey. In some embodiments, the passkey may correspond to a particular user device. To identify and select the corresponding authentication passkey requirement set for the user, the authentication circuitry 208 may use the user identifier, which may be included in the user operation request or in a subsequent request (e.g., a logon request) to identify the particular user device. The authentication circuitry 208 may determine the passkey associated with the user device 106A and, further, determine the authentication passkey requirement set that corresponds to the passkey.

As shown by operation 506, the apparatus 200 includes means, such as the communications hardware 206, the authentication circuitry 208, or the like, for performing an authentication routine. The authentication circuitry 208 may perform the authentication routine to authenticate the user operation request. In particular, the authentication routine may use a super passkey to authenticate the user operation request. As described in more detail in FIGS. 6, 7, and 8, authentication using a super passkey may require the authentication circuitry 208 to authenticate a digital signature received from the user device and determine whether the authentication passkey requirements from the authentication passkey requirement set are satisfied by current user device data. The combination of these operations form the basis for authentication using a super passkey.

In some embodiments, operation 506 may be performed in accordance with the operations described by FIG. 6. Turning now to FIG. 6, example operations are shown for performing an authentication routine to authenticate a user operation request.

As shown by operation 602, the apparatus 200 includes means, such as the memory 204, the communications hardware 206, the authentication circuitry 208, or the like, for authenticating a digital signature provided by a user device. In various embodiments, the authentication circuitry 208 may authenticate a signed challenge produced by the user device 106A. As described in further detail in FIG. 7, the authentication circuitry 208 may generate a challenge and use the communications hardware 206 to provide the challenge to the user device 106A. The user device 106A may use a private cryptographic key that corresponds to the passkey established with the apparatus 200 and/or the entity associated with the apparatus 200 to sign the challenge and produce a digital signature. The communications hardware 206 may then receive a challenge response that includes the digital signature. The authentication circuitry 208 may then authenticate the digital signature using the public cryptographic key of the passkey. The authentication circuitry 208 may perform a cryptographic verification to determine whether the digital signature generated by the user device 106A correctly corresponds to the original challenge. If the digital signature corresponds to the original challenge, the authentication circuitry 208 may determine the digital signature is successfully authenticated. If the digital signature fails to correspond to the original challenge, the authentication circuitry 208 may determine the digital signature has failed authentication.

In some embodiments, operation 602 may be performed in accordance with the operations described by FIG. 7. Turning now to FIG. 7, example operations are shown for authenticating a digital signature during an authentication routine.

As shown by operation 702, the apparatus 200 includes means, such as the memory 204, the authentication circuitry 208, or the like, for generating a challenge. In some embodiments, the authentication circuitry 208 may be configured to generate a random challenge to authenticate the user device 106A. A challenge may be a randomly generated piece of data, such as a number or a string. In some embodiments, the challenge is a nonce to ensure the subsequent authentication attempt is unique and cannot be reused or replayed by attackers. The authentication circuitry 208 may generate the challenge using any algorithm, such as a random or pseudo-random number generator (e.g., a 128-bit or 256-bit number generator). In some embodiments, the authentication circuitry 208 may store the challenge in the memory 204.

As shown by operation 704, the apparatus 200 includes means, such as the communications hardware 206 or the like for providing the challenge to the user device. Once the authentication circuitry 208 has generated the challenge, it may cause the communications hardware 206 to provide the challenge to the user device 106A. The communications hardware 206 may request the user device 106A provide a challenge response.

As shown by operation 706, the apparatus 200 includes means, such as the communications hardware 206 or the like for receiving a challenge response. In various embodiments, the user device 106A may sign the challenge using the private cryptographic key of the passkey to produce a digital signature. The communications hardware 206 may receive a challenge response that includes the digital signature from the user device 106A. In some embodiments, the challenge response may further include current user device data from the user device 106A.

As shown by operation 708, the apparatus 200 includes means, such as the memory 204, the authentication circuitry 208, or the like, for authenticating the digital signature provided in the challenge response. The authentication circuitry 208 may receive the digital signature from the communications hardware 206. In some embodiments, the authentication circuitry 208 uses the public cryptographic key of the passkey to authenticate the digital signature.

In some embodiments, the authentication circuitry 208 may authenticate the signed challenge if the signature corresponds to the public cryptographic key stored in the memory 204 of the apparatus 200, and the authentication of the signed challenge may allow for the user operation request to continue through to the next stage in the authentication process. In some embodiments, if the signed challenge does not correspond to the public key, the authentication circuitry 208 may reject the challenge and the user operation request may not be authenticated. The authentication circuitry 208 may perform a cryptographic verification to determine whether the digital signature correctly corresponds to the original challenge. In some embodiments, the authentication circuitry 208 may access the original signature from the memory 204. If the digital signature corresponds to the original challenge, the authentication circuitry 208 may determine the digital signature is successfully authenticated. If the digital signature fails to correspond to the original challenge, the authentication circuitry 208 may determine the digital signature has failed authentication.

In some embodiments, the authentication circuitry 208 may determine the challenge response was received within a threshold time window. If no challenge response is received within the threshold time window, the authentication circuitry 208 may determine the digital signature has failed authentication.

Returning now to FIG. 6, as shown by operation 604, the apparatus 200 includes means, such as the memory 204, the communications hardware 206, the authentication circuitry 208, or the like, for determining whether current user device data satisfies the one or more authentication passkey requirements. In some embodiments, the user device 106A may provide current user device data in a user operation request, a challenge response, or in one or more separate messages received by the communications hardware 206. The current user device data may provide current user device location data, a current time, an indication of proximate user device identifiers detected by the user device, and/or the like. The authentication circuitry 208 may access the authentication passkey requirement set associated with the user account and/or the passkey for the user device 106A from its storage location, such as the memory 204. The authentication circuitry 208 may then determine whether each authentication passkey requirement is satisfied based on the current user device data.

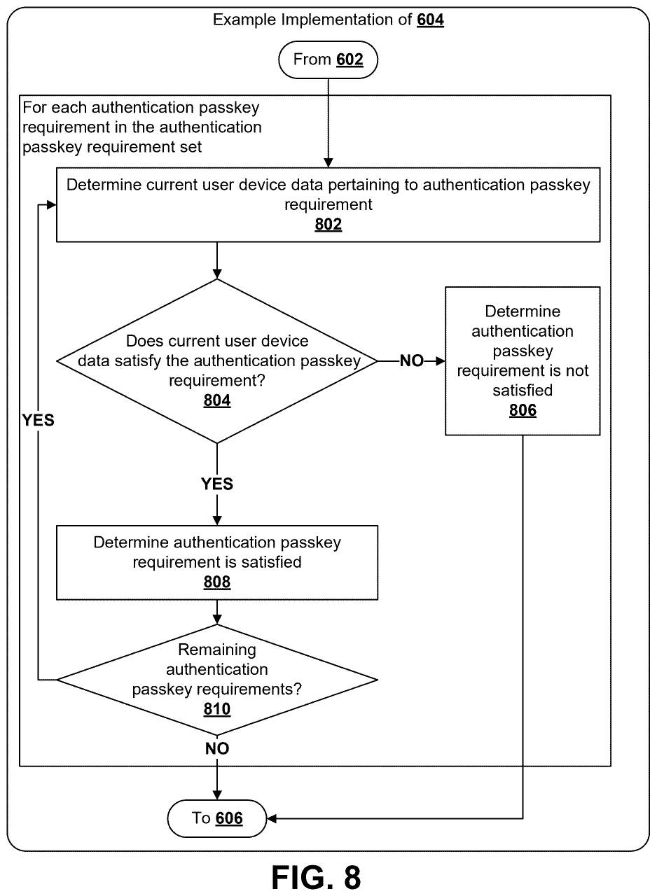

In some embodiments, operation 604 may be performed in accordance with the operations described by FIG. 8. Turning now to FIG. 8, example operations are shown for determining whether authentication passkey requirements are satisfied during an authentication routine. As described above, the authentication passkey requirement set may include one or more authentication passkey requirements. The authentication circuitry 208 may access the authentication passkey requirement set from the memory 204 and perform the operations of FIG. 8 for each authentication passkey requirement. Additionally, in some embodiments, the authentication circuitry 208 may further determine the authentication passkey requirements for the particular user operation request. That is, authentication passkey requirements may be applicable to particular operation request types. Thus, the authentication circuitry 208 may ignore irrelevant authentication passkey requirements that may be in the authentication passkey requirement set.

As shown by operation 802, the apparatus 200 includes means, such as the communications hardware 206, the authentication circuitry 208, or the like, for determining the current user device data pertaining to the authentication passkey requirement. In some embodiments, the authentication circuitry 208 may analyze the received current user device data from the user device 106A. As described above, an authentication passkey requirement may define a rule, requirement, or condition for when a passkey may be used for a user and/or user device 106A for authentication. To ensure the rule, requirement, or condition is satisfied, the authentication passkey requirement may require particular current user device data to be analyzed. For example, an authentication passkey requirement to enable a passkey to be used for authentication in all trusted geographic locations may require location data in the current user device data.

As described above, the current user device data may be received by the communications hardware 206 in a user operation request, a challenge response, or in one or more separate messages. In some embodiments, the authentication circuitry 208 may determine whether user device data needed for a particular authentication passkey requirement is missing. If required user device data is missing, the authentication circuitry 208 may cause the communications hardware 206 to request the missing user device data from the user device 106A.

As shown by operation 804, the apparatus 200 includes means, such as the memory 204, the authentication circuitry 208, or the like, for determining whether the current user device data satisfies the authentication passkey requirement. Once the authentication circuitry 208 has identified the pertinent, required, or otherwise relevant user device data for the authentication passkey requirement, the authentication circuitry 208 may determine whether the current user device data satisfies the authentication passkey requirement. In particular, the authentication circuitry 208 may determine whether the current user device data satisfies a requirement and/or whether the current user device data violates a condition.

By way of particular example, an authentication passkey requirement may define that a passkey may be used for authentication when the user device is in or within a trusted location. A user may configure his/her account with trusted locations such that the authentication circuitry 208 may use the user account to identify one or more trusted locations. A trusted location may be associated with an address, global positioning system (GPS) coordinates, an IP address, a geographic region (e.g., a ZIP code, city, state, country, or the like), and/or the like. In some embodiments, the current user device data may include location data. The current user device data may include current GPS coordinates of the user device 106A, a current IP address of the user device 106A, and/or the like. The authentication circuitry 208 may use the location data included in the current user device data to determine whether the user device is at or within a trusted location. If the location data is indicative that the user device 106A is within a trusted location, this authentication passkey requirement is satisfied. Otherwise, the authentication passkey requirement is not satisfied.

As another example, an authentication passkey requirement may define that a passkey cannot be used for authentication when the user device is in or within an excluded location. An excluded location may be associated with an address, GPS coordinates, an IP address, a geographic region (e.g., a ZIP code, city, state, country, or the like), and/or the like. In some embodiments, the current user device data may include location data. The current user device data may include current GPS coordinates of the user device 106A, a current IP address of the user device 106A, and/or the like. The authentication circuitry 208 may use the location data included in the current user device data to determine whether the user device is at or within an excluded location. If the location data is indicative that the user device 106A is within an excluded location, the authentication passkey requirement fails to be satisfied. If the location data is indicative that the user device 106A is not within an excluded location, the authentication passkey requirement is satisfied.

As another example, an authentication passkey requirement may define a time frame within which a passkey can or cannot be used for authentication. In some embodiments, the current user device data may include a current time. The authentication circuitry 208 may use the current time included in the current user device data to determine whether the current time is within the time frame a passkey can be used for authentication or cannot be used for authentication. If the current time is within a time frame during which a passkey can be used for authentication, the authentication passkey requirement is satisfied. If the current time is within a time frame during which a passkey cannot be used for authentication, the authentication passkey requirement fails to be satisfied.

As another example, an authentication passkey requirement may define the presence of a device identifier of another user device (e.g., a user device other than the user device performing the authentication) is required in order for the passkey to be used for authentication. In some embodiments, the user device 106A may obtain a device identifier of another device (e.g., user device 106N) using Bluetooth, near-field communication, scanning a QR code provided by the user device 106N, and/or the like. The user device 106A may further determine a device identifier for the user device 106N if both user devices are on the same network (e.g., a local area network or wide area network). The current user device data may include a device identifier for each proximate user device. The authentication circuitry 208 may use the device identifiers included in the current user device data to determine whether a required user device is present and/or proximate to the user device 106A. If a required device identifier is included in the current user device data, the authentication passkey requirement is satisfied. If a required device identifier is not included in the current user device data, the authentication passkey requirement fails to be satisfied.

In some embodiments, an authentication passkey requirement may define a security requirement in order for the passkey to be used for authentication. For example, the security requirement may define a required software application version for an associated software application installed on the user device 106A. In some embodiments, the current user device data may include the current software application version used by the user device 106A. Additionally, or alternatively, in some embodiments, the user account may include an indication of the current software version used by the user device 106A. The authentication circuitry 208 may use the current software application version included in the current user device data and/or the user account to determine whether the current software application version satisfies the required software application version (e.g., the current software application version is the required software application version or higher). If the current software application version satisfies the required software application version, the authentication passkey requirement is satisfied. If the current software application version fails to satisfy the required software application version, the authentication passkey requirement fails to be satisfied.

If the current user device data fails to satisfy the authentication passkey requirement, the process may proceed to operation 806. As shown by operation 806, the apparatus 200 includes means, such as the authentication circuitry 208 or the like, for determining the authentication passkey requirement is not satisfied. If an authentication passkey requirement fails to be satisfied, the process may skip any remaining authentication passkey requirements and proceed to operation 606 and subsequently to operation 608. If an authentication passkey requirement in the authentication passkey requirement set fails to be satisfied, the user operation request fails to be satisfied. Thus, even if the digital signature provided by the user device is successfully authenticated, the user operation request still fails to be authenticated.

If the current user device data satisfies the authentication passkey requirement, the process may proceed to operation 808. As shown by operation 808, the apparatus 200 includes means, such as the authentication circuitry 208 or the like, for determining the authentication passkey requirement is satisfied. Once an authentication passkey requirement is determined to be satisfied, the process may proceed to operation 810.

As shown by operation 810, the apparatus 200 includes means, such as the authentication circuitry 208 or the like, for determining whether there are remaining authentication passkey requirements. Once an authentication passkey requirement is satisfied, the authentication circuitry 208 may determine whether there are remaining authentication passkey requirements in the authentication passkey requirement set that have not been evaluated. If so, the process may proceed to operation 802 for the yet-to-be-evaluated authentication passkey requirement. If each authentication passkey requirement has been evaluated and was successfully authenticated, the process may proceed to operation 606 and subsequently to operation 610.

Returning now to FIG. 6, as shown by operation 606, the apparatus 200 includes means, such as the authentication circuitry 208 or the like, for a determining whether both the digital signature was successfully authenticated and whether each of the authentication passkey requirements were satisfied. If either the digital signature failed to be authenticated and/or one or more of the authentication passkey requirements failed to be satisfied, the process may proceed to operation 608. If the digital signature is successfully authenticated and the authentication passkey requirements are each satisfied, the process may proceed to operation 610.

As shown by operation 608, the apparatus 200 includes means, such as the authentication circuitry 208 or the like, for failing to authenticate the user operation request.

As shown by operation 610, the apparatus 200 includes means, such as the authentication circuitry 208 or the like, for successfully authenticating the user operation request.

Returning now to FIG. 5, as shown by operation 508, the apparatus 200 includes means, such as the authentication circuitry 208 or the like, for determining whether authentication of the user operation request was successful. As described above, the authentication circuitry 208 performs the authentication routine to determine whether a digital signature received from the user device is successfully authenticated and whether the authentication passkey requirements from the authentication passkey requirement set are satisfied by current user device data. If both these conditions are satisfied, the authentication circuitry 208 determines the user operation request is successfully authenticated. If one or more of these conditions fail to be satisfied (e.g., the digital signature fails to be authenticated and/or one or more authentication passkey requirements are not satisfied by current user device data), the authentication circuitry 208 determines the user operation request fails.

If the user operation request fails to be authenticated, the process may proceed to operation 510. As shown by operation 510, the apparatus 200 includes means, such as the communications hardware 206, the authentication circuitry 208, or the like, for rejecting the user operation request. If the authentication circuitry 208 fails to authenticate the user operation request, this may be indicative that the user device identity is unable to be verified, the user identity is unable to be verified, or the user operation request violates one or more conditions under which the passkey can be used. Thus, the authentication circuitry 208 may reject the user operation request. In some embodiments, the authentication circuitry 208 may further cause the communications hardware 206 to provide a rejection notification to the user device 106A.

The rejection notification may include feedback on why the user operation request was rejected. For example, the rejection notification request may indicate that the passkey provided by the user device 106A could not be authenticated or an authentication passkey requirement was not satisfied. If an authentication passkey requirement was not satisfied, the rejection notification may further indicate the authentication passkey requirement that failed to be satisfied. Thus, the rejection notification may provide the user with a reason for the user operation request rejection. The user may then evaluate whether he/she would like to update user configuration preferences to reflect changes. For example, the user has recently moved but did not list his/her current residential address as a trusted location and this was the reason for the user operation request failure. The user may rectify this by updating his/her user account to reflect the new address as a trusted location and/or may provide a user configuration preference as described in FIG. 4. This may cause the authentication passkey requirement set to be updated. The user may then reattempt the user operation request, and the operations of FIG. 5 may be performed for the new user operation request.

If the user operation request is successfully authenticated, the process may proceed to operation 512. As shown by operation 512, the apparatus 200 includes means, such as the memory 204, the communications hardware 206, the operation management circuitry 212, or the like, for performing an operational routine. If the authentication circuitry 208 successfully authenticates the user operation request, the authentication circuitry 208 may prompt or authorize the operation management circuitry 212 to perform an operation routine associated with the user operation request. As described above, the user operation request may correspond to a particular category of predefined user request types. Each operation request type may be associated with an operational routine. The operational routine may include a set of instructions to be performed by the operation management circuitry 212 to fulfill the user operation request.

In some embodiments, the operational routine for each operation request type is stored in an associated memory, such as the memory 204. The operation management circuitry 212 may access the operational routine for the operation request type from the memory 204. The operation management circuitry 212 may then perform the operations and/or execute the instructions for the operational routine to fulfill the user operation request. In some embodiments, the operation management circuitry 212 may perform the operational routine based on the user-supplied data provided in the user operation request.

By way of particular example, an operation request type may be a user account logon request, and the user-supplied data may be a user credential. The operational routine may instruct the operation management circuitry 212 to cause the communications hardware 206 to establish a secure session with the requesting user device. Thus, the operation management circuitry 212 may cause the communications hardware 206 to establish a secure session with the user device 106A. This may be performed in a substantially similar manner as described in operation 410 of FIG. 4.

As another example, an operation request type may be a fund transfer request and the user-supplied data may include a provisioning account, a recipient account, a fund amount, and a memo line. The operational routine may instruct the operation management circuitry 212 to transfer funds of a specified fund amount from the provisioning account to the recipient account. Further, the operational routine may instruct the operation management circuitry 212 to provide the text in the memo line to the recipient account. Thus, the operation management circuitry 212 may cause funds in the amount specified in the user operation request to transfer from the provisioning account to the recipient account along with providing text in the memo line.

As another example, an operation request type may be a user account update request and the user-supplied data may include user input values for a particular user account data field (e.g., legal name, residential address, work address, phone number, trusted user devices, trusted locations, or the like). The operational routine may instruct the operation management circuitry 212 to update the user account to reflect the user input values for the corresponding data fields. Thus, the operation management circuitry 212 may cause the user account to be updated to reflect the user input values provided in the user operation request.

As yet another example, an operation request type may be a new account opening request and the user-supplied data may include various demographic information, a social security number, a phone number, an email address, etc. The operational routine may instruct the operation management circuitry 212 to generate a new account corresponding to the request account type for the user account and update the data fields in the user account with the provided user-supplied data. Thus, the operation management circuitry 212 may generate a new account for the user and automatically input the user-supplied data values in the corresponding data fields for the new account. In some embodiments, the operational routine may further instruct the operation management circuitry 212 to link the new user account and the current user account such that user operations requests pertaining to the new user account may be authenticated using the passkey currently associated with the user account, the user device 106A, and/or the authentication passkey requirement set for the passkey.

The operation management circuitry 212 may further cause the communications hardware 206 to provide a request status message to the user device 106A. The request status message may indicate the current status of the user operation request such that the user may be informed of the real-time status for completion of the user operation request. The request status message may further inform the user of whether the user operation request has been completed. In some embodiments, the request status message may serve as a receipt of the completion of the user operation request.

### Example User Device Operations

Turning to FIG. 9, example flowcharts are illustrated that contain example operations implemented by example embodiments described herein. The operations illustrated in FIG. 9 may, for example, be performed by a user device (e.g., any one of the user devices 106A-106N) shown in FIG. 1, which may in turn be embodied by the apparatus 300, which is shown and described in connection with FIG. 3. To perform the operations described below, the apparatus 300 may utilize one or more of the processor 302, the memory 304, the communications hardware 306, the authentication configuration circuitry 308, and/or any combination thereof.

Turning now to FIG. 9, example operations are shown for locally storing a device configuration set. By locally storing a device configuration set, the apparatus 300 may use the device configuration set to ensure efficient and streamlined communication between the passkey authentication system 102 and apparatus 300 by eliminating the need for the passkey authentication system 102 to request data required for authentication with a passkey. Instead, the apparatus 300 may use the device configuration set to proactively provide the required data, thereby conserving network bandwidth usage. Furthermore, the apparatus 300 may use the device configuration set to identify the required user device data needed for a particular authentication and then provide only the required data. Effectively, this allows the apparatus 300 to reduce the communication payload to only the required user device data, thereby further reducing network bandwidth usage.

As shown by operation 902, the apparatus 300 includes means, such as the communications hardware 306 or the like, for providing a logon request. In some embodiments, the communications hardware 306 may receive user input that includes a candidate user identifier, a candidate user credential, and a request to provide the logon request from the user. In response, the communications hardware 306 may provide the logon request to the passkey authentication system 102. The logon request may correspond to a request to access a user account within an associated software application.

As shown by operation 904, the apparatus 300 includes means, such as the processor 302, the memory 304, the communications hardware 306, or the like, for establishing a secure connection with the apparatus 300. As described in operation 410 of FIG. 4, a secure session may be established between the apparatus 300 and the passkey authentication system 102. In some embodiments, the communications hardware 306 may receive a session token and the session token may be stored in the memory 304. The apparatus 300 may provide the user with access to the user account within the software application during the duration of the secure session.

As shown by operation 906, the apparatus 300 includes means, such as the processor 302, the communications hardware 306, or the like, for receiving user input indicative of a user configuration preference. During the secure session, the communications hardware 306 may receive user input for a new or updated user configuration preference with respect to a user account. This user input may be received within a specific page or endpoint within the software application.

For example, the user may input a user configuration preference to allow a passkey for the apparatus 300 to be used whenever the apparatus 300 is within a trusted location.

As shown by operation 908, the apparatus 300 includes means, such as the communications hardware 306 or the like, for providing the user configuration preference. In some embodiments, the communications hardware 306 may provide the one or more user configuration preferences to the passkey authentication system 102.

As shown by operation 910, the apparatus 300 includes means, such as the communications hardware 306 or the like, for receiving the device configuration set. In some embodiments, the communications hardware 306 may receive the device configuration set from the passkey authentication system 102.

As shown by operation 912, the apparatus 300 includes means, such as the processor 302, the memory 304, or the like, for storing the device configuration set. In various embodiments, the device configuration set, generated by the passkey authentication system 102, may be stored in the memory 304 of the apparatus 300. The device configuration set may include one or more device configuration parameters that are intended to be stored locally in the memory 304. A device configuration parameter may provide data and/or instructions for the authentication configuration circuitry 308 when providing a user operation request. In some embodiments, a device configuration parameter may instruct the authentication configuration circuitry 308 to cause the communications hardware 306 to provide certain user device data, such as a user device location, a current time, proximate device identifiers detected, and/or the like, to the passkey authentication system 102. Device configuration parameters may further instruct the authentication configuration circuitry 308 to cause the communications hardware 306 to provide certain user device data for a particular user operation request. Additionally, in some embodiments, device configuration parameters may instruct the authentication configuration circuitry 308 to cause the communications hardware 306 to provide in a particular manner. For example, a device configuration parameter may instruct the authentication configuration circuitry 308 to cause the communications hardware 306 to provide a device configuration parameter over a particular communication channel, using a particular frequency, separately or with other user device data and/or a signed challenge, in a protected manner (e.g., a particular encryption technique), and/or the like.

FIG. 4-9 illustrate operations performed by apparatuses, methods, and computer program products according to various example embodiments. It will be understood that each flowchart block, and each combination of flowchart blocks, may be implemented by various means, embodied as hardware, firmware, circuitry, and/or other devices associated with execution of software including one or more software instructions. For example, one or more of the operations described above may be implemented by execution of software instructions. As will be appreciated, any such software instructions may be loaded onto a computing device or other programmable apparatus (e.g., hardware) to produce a machine, such that the resulting computing device or other programmable apparatus implements the functions specified in the flowchart blocks. These software instructions may also be stored in a non-transitory computer-readable memory that may direct a computing device or other programmable apparatus to function in a particular manner, such that the software instructions stored in the computer-readable memory comprise an article of manufacture, the execution of which implements the functions specified in the flowchart blocks.

The flowchart blocks support combinations of means for performing the specified functions and combinations of operations for performing the specified functions. It will be understood that individual flowchart blocks, and/or combinations of flowchart blocks, can be implemented by special-purpose, hardware-based computing devices that perform the specified functions or combinations of special-purpose hardware and software instructions.

In some embodiments, some of the operations described above in connection with FIG. 4-9 may be modified or further amplified. Furthermore, in some embodiments, additional optional operations may be included. Modifications, amplifications, or additions to the operations above may be performed in any order and in any combination.

### Conclusion

As described above, example embodiments provide methods and apparatuses that enable use of a super passkey for enhanced user account security. Example embodiments, thus, provide tools that overcome the problems faced by tradition passkey systems, which provide only a static level of authentication and, further, fail to provide additional security requirements. In contrast, the use of a super passkey contemplates the use of additional user device data for authentication and, thus, example embodiments increase security of the passkey. Further, in some embodiments, the current user device data is automatically provided to the system such that the user is not burdened. Moreover, embodiments described herein allow for the user to have improved control over the security of his/her accounts by allowing the user to submit user configuration preferences, which are used when generating the authentication passkey requirement set. Additionally, by considering the entity configuration security requirement set, resulting authentication passkey requirements are ensured to be complaint with various security and/or regulatory requirements. Further, the authentication passkey requirements may be specific to different operation request types, thereby providing flexibility when authenticating user operation requests.

As these examples all illustrate, example embodiments contemplated herein provide technical solutions that solve real-world problems faced during passkey authentication. Recent progress in cryptanalysis in a post-quantum computing environment has made passkey authentication a potential target. At the same time, the rising ubiquity of user devices that may provide additional user data on a device has unlocked new avenues for improving the security of passkey authentication, and example embodiments described herein thus represent a technical solution to these real-world problems.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method for improved authentication, the method comprising:
receiving, by communications hardware, a user operation request from a user device, wherein the user operation request pertains to a user account and corresponds to an operation request type;
determining, by authentication circuitry and based on the user account, an authentication passkey requirement set comprising one or more authentication passkey requirements required for authentication of the user operation request;
performing, by the authentication circuitry, an authentication routine to determine whether to authenticate the user operation request, wherein the authentication routine comprises:
authenticating, by the authentication circuitry, a digital signature provided by the user device using a public cryptographic key of a passkey for the user account, and
determining, by the authentication circuitry, whether current user device data satisfies the one or more authentication passkey requirements, wherein the user operation request is successfully authenticated in an instance in which the digital signature is successfully authenticated and the current user device data satisfies each of the one or more authentication passkey requirements; and
in an instance in which the user operation request is successfully authenticated, performing, by operation management circuitry and based on the user operation request, an operational routine associated with the operation request type for the user account.

2. The method of claim 1, further comprising:
identifying, by configuration circuitry, a user configuration preference set from the user account, wherein the user configuration preference set defines user-defined conditions under which the passkey can be used for authentication;
identifying, by the configuration circuitry, an entity configuration security requirement set, wherein the entity configuration security requirement set defines entity-defined conditions under which the passkey can be used for authentication; and
generating, by the configuration circuitry, the authentication passkey requirement set based on the user configuration preference set and the entity configuration security requirement set.

3. The method of claim 1, further comprising:
determining, by the authentication circuitry, a location of the user device from the current user device data;
determining, by the authentication circuitry, whether the location of the user device corresponds to a trusted location for the operation request type as defined by an authentication passkey requirement of the one or more authentication passkey requirements; and
in an instance in which the location of the user device is determined to correspond to the trusted location, determining, by the authentication circuitry, the authentication passkey requirement is satisfied.

4. The method of claim 1, further comprising:
determining, by the authentication circuitry, a location of the user device from the current user device data;
determining, by the authentication circuitry, whether the location of the user device corresponds to an excluded location for the operation request type as defined by an authentication passkey requirement of the one or more authentication passkey requirements; and
in an instance in which the location of the user device fails to correspond to the excluded location, determining, by the authentication circuitry, the authentication passkey requirement is satisfied.

5. The method of claim 1, further comprising:
determining, by the authentication circuitry, a current time pertaining to the user device;
determining, by the authentication circuitry, whether the current time is within a trusted timeframe for the operation request type as defined by an authentication passkey requirement of the one or more authentication passkey requirements; and
in an instance in which the current time is determined to be within the trusted timeframe, determining, by the authentication circuitry, the authentication passkey requirement is satisfied.

6. The method of claim 1, further comprising:
determining, by the authentication circuitry, a current software application version for an associated software application installed on the user device from the current user device data;
determining, by the authentication circuitry, whether the current software application version satisfies a software application version threshold for the operation request type as defined by an authentication passkey requirement of the one or more authentication passkey requirements; and
in an instance in which the current software application version is determined to satisfy the software application version threshold, determining, by the authentication circuitry, the authentication passkey requirement is satisfied.

7. The method of claim 1, further comprising:
determining, by the authentication circuitry, a user device identifier corresponding to a second user device from the current user device data;
determining, by the authentication circuitry, whether the user device identifier corresponds to a trusted user device identifier defined by an authentication passkey requirement of the one or more authentication passkey requirements; and
in an instance in which the user device identifier is determined to correspond to the trusted user device identifier, determining, by the authentication circuitry, the authentication passkey requirement is satisfied.

8. The method of claim 1, further comprising:
generating, by the authentication circuitry, a challenge;
providing, by the communications hardware, the challenge to the user device; and
in response to providing the challenge, receiving, by the communications hardware, a challenge response comprising the digital signature from the user device.

9. The method of claim 1, further comprising:
receiving, by the communications hardware, a logon request for the user account;
authenticating, by the authentication circuitry, the logon request based on user credentials provided in the logon request;
in an instance in which the logon request is successfully authenticated, establishing, by the communications hardware, a secure session with the user device;
during the secure session, receiving, by the communications hardware, a user configuration preference from the user device; and
updating, by configuration circuitry, the user account to include the user configuration preference in a user configuration preference set.

10. The method of claim 1, further comprising:
generating, by configuration circuitry and based on the authentication passkey requirement set, a device configuration set comprising one or more device authentication rules that are indicative of user device data to provide in response to a received challenge; and
providing, by the communications hardware, the device configuration set to the user device.

11. An apparatus for improved authentication, the apparatus comprising:
communications hardware configured to receive a user operation request from a user device, wherein the user operation request pertains to a user account and corresponds to an operation request type;
authentication circuitry configured to:
determine, based on the user account, an authentication passkey requirement set comprising one or more authentication passkey requirements required for authentication of the user operation request,
perform an authentication routine to determine whether to authenticate the user operation request, wherein the authentication circuitry is configured to perform the authentication routine by:
authenticating a digital signature provided by the user device using a public cryptographic key of a passkey for the user account, and
determining whether current user device data satisfies the one or more authentication passkey requirements, wherein the user operation request is successfully authenticated in an instance in which the digital signature is successfully authenticated and the current user device data satisfies each of the one or more authentication passkey requirements; and
operation management circuitry configured to, in an instance in which the user operation request is successfully authenticated, perform, based on the user operation request, an operational routine associated with the operation request type for the user account.

12. The apparatus of claim 11, further comprising configuration circuitry configured to:
identify a user configuration preference set from the user account, wherein the user configuration preference set defines user-defined conditions under which the passkey can be used for authentication;
identify an entity configuration security requirement set, wherein the entity configuration security requirement set defines entity-defined conditions under which the passkey can be used for authentication; and
generate the authentication passkey requirement set based on the user configuration preference set and the entity configuration security requirement set.

13. The apparatus of claim 11, wherein the authentication circuitry is further configured to:
determine a location of the user device from the current user device data;
determine whether the location of the user device corresponds to a trusted location for the operation request type as defined by an authentication passkey requirement of the one or more authentication passkey requirements; and
in an instance in which the location of the user device is determined to correspond to the trusted location, determine the authentication passkey requirement is satisfied.

14. The apparatus of claim 11, wherein the authentication circuitry is further configured to:
determine a location of the user device from the current user device data;
determine whether the location of the user device corresponds to an excluded location for the operation request type as defined by an authentication passkey requirement of the one or more authentication passkey requirements; and
in an instance in which the location of the user device fails to correspond to the excluded location, determine the authentication passkey requirement is satisfied.

15. The apparatus of claim 11, wherein the authentication circuitry is further configured to:
determine a current time pertaining to the user device;
determine whether the current time is within a trusted timeframe for the operation request type as defined by an authentication passkey requirement of the one or more authentication passkey requirements; and
in an instance in which the current time is determined to be within the trusted timeframe, determine the authentication passkey requirement is satisfied.

16. The apparatus of claim 11, wherein the authentication circuitry is further configured to:
determine a current software application version for an associated software application installed on the user device from the current user device data;
determine whether the current software application version satisfies a software application version threshold for the operation request type as defined by an authentication passkey requirement of the one or more authentication passkey requirements; and
in an instance in which the current software application version is determined to satisfy the software application version threshold, determine the authentication passkey requirement is satisfied.

17. The apparatus of claim 11, wherein the authentication circuitry is further configured to:
determine a user device identifier corresponding to a second user device from the current user device data;
determine whether the user device identifier corresponds to a trusted user device identifier defined by an authentication passkey requirement of the one or more authentication passkey requirements; and
in an instance in which the user device identifier is determined to correspond to the trusted user device identifier, determine the authentication passkey requirement is satisfied.

18. The apparatus of claim 11, wherein the authentication circuitry is further configured to generate a challenge;
wherein the communications hardware is further configured to:
provide the challenge to the user device, and
in response to providing the challenge, receive a challenge response comprising the digital signature from the user device.

19. The apparatus of claim 11, wherein the communications hardware is further configured to receive a logon request for the user account;
wherein the authentication circuitry is further configured to authenticate the logon request based on user credentials provided in the logon request;
wherein the communications hardware is further configured to:
in an instance in which the logon request is successfully authenticated, establish a secure session with the user device, and
during the secure session, receive a user configuration preference from the user device;
wherein the apparatus further comprises configuration circuitry configured to update the user account to include the user configuration preference in a user configuration preference set.

20. A computer program product for improved authentication, the computer program product comprising at least one non-transitory computer-readable storage medium storing software instructions that, when executed, cause an apparatus to:
receive a user operation request from a user device, wherein the user operation request pertains to a user account and corresponds to an operation request type;
determine, based on the user account, an authentication passkey requirement set comprising one or more authentication passkey requirements required for authentication of the user operation request;
perform an authentication routine to determine whether to authenticate the user operation request, wherein the authentication routine comprises:
authenticating a digital signature provided by the user device using a public cryptographic key of a passkey for the user account, and
determining whether current user device data satisfies the one or more authentication passkey requirements, wherein the user operation request is successfully authenticated in an instance in which the digital signature is successfully authenticated and the current user device data satisfies each of the one or more authentication passkey requirements; and
in an instance in which the user operation request is successfully authenticated, perform, based on the user operation request, an operational routine associated with the operation request type for the user account.
